(19) United States
(12) Patent Application Publication
(10) Pub. No.: US 2024/0236479 A9
(43) Pub. Date: Jul. 11, 2024

(54) METHOD FOR ADJUSTING OBJECT DURING PHOTOGRAPHING AND ELECTRONIC DEVICE

(71) Applicant: BEIJING DAJIA INTERNET INFORMATION TECHNOLOGY CO., LTD., Beijing (CN)

(72) Inventors: Ying CHEN, Beijing (CN); Yueran XU, Beijing (CN); Zihui YE, Beijing (CN)

(21) Appl. No.: 18/471,925

(22) Filed: Sep. 21, 2023

(30) Foreign Application Priority Data
Oct. 21, 2022 (CN) 202211299565.5

(51) Int. Cl. H04N 23/63; H04N 5/262

(52) U.S. Cl. CPC H04N 23/632; H04N 5/2621; H04N 23/635

(57) ABSTRACT

Provided is a method for adjusting objects during photographing. The method includes: displaying a to-be-photographed object in an object preview interface; adjusting a target sub-object in response to an adjustment instruction to the target sub-object of the to-be-photographed object; and displaying position indication information in the object preview interface, wherein the position indication information indicates a position of the adjusted target sub-object in the object preview interface.

This disclosure is based on and claims priority to Chinese Patent Application No. 202211299565.5, filed on Oct. 21, 2022, the disclosure of which is herein incorporated by reference in its entirety.

### TECHNICAL FIELD

The present disclosure related to the field of Internet technologies, and in particular, relates to a method for adjusting objects during photographing and an electronic device.

### BACKGROUND

With the rapid development of the digital technology in the past two to three decades, it has become a fashion for people to record their lives by taking photos. Nowadays, more and more electronic devices support photo taking, such as mobile phones, digital cameras, PDAs, or the like. When users take photos with these devices, in order to take satisfactory photos, they usually need to use software that has the function of retouching the photos. With the increasing popularity of photo retouching software, people have higher requirements for the beautification function of the photo retouching software, and hope that a beautification effect is closer to the reality while also higher than the real effect. For photo retouching software application, people are sensitive to some common effects such as skin beautification, and skin smoothing.

### SUMMARY

Embodiments of the present disclosure provide a method for adjusting objects during photographing and an electronic device.

According to some embodiments of the present disclosure, a method for adjusting objects during photographing is provided.

The method includes: displaying a to-be-photographed object in an object preview interface; adjusting a target sub-object in response to an adjustment instruction to the target sub-object of the to-be-photographed object; and displaying position indication information in the object preview interface, wherein the position indication information indicates a position of the adjusted target sub-object in the object preview interface.

According to some embodiments of the present disclosure, an electronic device is provided. The device includes a processor and a memory configured to store one or more instructions executable by the processor, wherein the processor, when loading and running the one or more instructions, is caused to: display a to-be-photographed object in an object preview interface; adjust a target sub-object in response to an adjustment instruction to the target sub-object of the to-be-photographed object; and display position indication information in the object preview interface, wherein the position indication information indicates a position of the adjusted target sub-object in the object preview interface.

According to some embodiments of the present disclosure, a non-transitory computer readable storage medium storing one or more instructions therein is provided. The one or more instructions, when loaded and executed by a processor of an electronic device, cause the electronic device to: display a to-be-photographed object in an object preview interface; adjust a target sub-object in response to an adjustment instruction to the target sub-object of the to-be-photographed object; and display position indication information in the object preview interface, wherein the position indication information indicates a position of the adjusted target sub-object in the object preview interface.

According to some embodiments of the present disclosure, a non-transitory computer program product is provided. The computer program product includes one or more computer programs, wherein the one or more computer programs are stored in a readable storage medium. The one or more computer programs, when loaded and run by at least one processor of a computer device, cause the computer device to: display a to-be-photographed object in an object preview interface; adjust a target sub-object in response to an adjustment instruction to the target sub-object of the to-be-photographed object; and display position indication information in the object preview interface, wherein the position indication information indicates a position of the adjusted target sub-object in the object preview interface.

### BRIEF DESCRIPTION OF DRAWINGS

FIG. 1 is a schematic diagram of an application environment according to some embodiments of the present disclosure;

FIG. 2 is a flowchart of a method for adjusting objects during photographing according to some embodiments of the present disclosure;

FIG. 3 is a first schematic diagram of an object preview interface according to some embodiments of the present disclosure;

FIG. 4 is a second schematic diagram of an object preview interface according to some embodiments of the present disclosure;

FIG. 5 is a flowchart of a method for displaying a target sub-object before and after adjustment according to some embodiments of the present disclosure;

FIG. 6 is a flowchart of a method for photographing a to-be-photographed object according to some embodiments of the present disclosure;

FIG. 7 is a flowchart of adjusting an adjustment parameter according to some embodiments of the present disclosure;

FIG. 8 is a block diagram of an apparatus for adjusting objects during photographing according to some embodiments of the present disclosure; and

FIG. 9 is a block diagram of an electronic device for adjusting objects during photographing according to some embodiments of the present disclosure.

### DETAILED DESCRIPTION

It should be noted that the user information (including, but not limited to, user device information, user personal information, or the like) and data (including, but not limited to, data used for display, data used for analytics, or the like) to which this disclosure relates are authorized by the user or fully authorized by the parties.

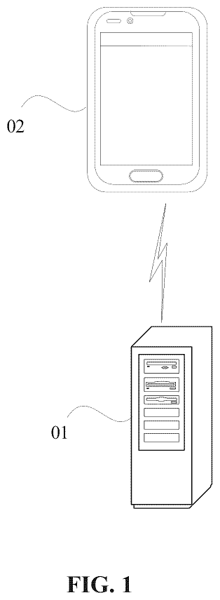

Referring to FIG. 1, FIG. 1 is a schematic diagram of an application environment for a method for adjusting objects during photographing according to some embodiments of the present disclosure. As shown in FIG. 1, the application environment includes a server 01 and a client 02.

In some embodiments, the server 01 is an independent physical server, or, a server cluster or distributed system including a plurality of physical servers, or a cloud server that provides basic cloud computing services such as a cloud service, a cloud database, a cloud computing, a cloud function, a cloud storage, a network service, a cloud communication, a middleware service, a domain name service, a security service, a content delivery network (CDN), big data, and an Artificial Intelligence platform. Operating systems running on the servers include, but are not limited to, Android, iOS, Linux, Windows, Unix, or the like.

In some possible embodiments, the above client 02 is a smartphone, a desktop computer, a tablet computer, a laptop computer, a smart speaker, a digital assistant, an augmented reality (AR)/virtual reality (VR) device, a smart wearable device, and the like. Alternatively, the client 02 is a software, such as an application, applet, etc., running on a smartphone, a desktop computer, a tablet computer, a laptop computer, a smart speaker, a digital assistant, an augmented reality/virtual reality (AR)/virtual reality (VR) device, a smart wearable device, and the like. In some embodiments, the operating system running on the client includes, but is not limited to, Android, iOS, Linux, Windows, Unix, or the like.

In some possible embodiments, the client 02 displays the to-be-photographed object in the object preview interface, adjusts the target sub-object in response to an adjustment instruction to the target sub-object of the to-be-photographed object, and displays position indication information in the object preview interface. The position indication information indicates a position of the adjusted target sub-object in the object preview interface. In the embodiments of the present disclosure, in the object preview interface, through the position of the adjusted target sub-object indicated by the position indication information, the user can perceive the adjusting function of the object clearly and explicitly, and thus improves the user's utilization of the application for providing the adjusting function.

In some embodiments of the present disclosure, the database corresponding to the client and the server is a node device in the block chain system, which is capable of sharing the acquired information as well as generated information to other node devices in the block chain system, realizing information sharing among the plurality of node devices. The plurality of node devices in the block chain system are provided with one block chain, which includes a plurality of blocks. The blocks adjacent to each other are correlated, such that any tampering of data in any block can be detected by the next block. In this way, tampering of data in the block chain is prevented, and the security and reliability of data in the block chain are ensured.

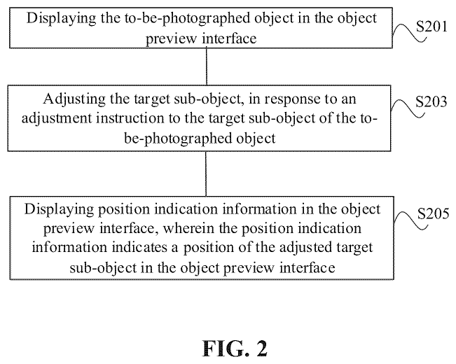

FIG. 2 is a flowchart of a method for adjusting objects during photographing. As shown in FIG. 2, according to some embodiments of the present disclosure, the method for adjusting objects during photographing is performed by a client. The method includes the following steps.

In S201, the to-be-photographed object is displayed in the object preview interface.

In embodiments of the present disclosure, the client is able to display the to-be-photographed object in the object preview interface.

In some embodiments, the client is a device including an image acquiring component. The image acquisition component is configured to acquire images. For example, the client is a smart mobile terminal (smartphone, smartwatch, smart glasses), and the smart mobile terminal includes a camera. In some embodiments, the client is an image capture device, such as a camera, a camcorder, or the like.

In some embodiments, taking the client being the smart mobile terminal as an example, the user is able to open an image acquiring application on the smart mobile terminal, the smart mobile terminal displays an object preview interface through the image acquisition application, and the to-be-photographed object is displayed in the object preview interface. In some embodiments, the object preview interface includes photographing controls and beautification controls.

In some embodiments of the present disclosure, the to-be-photographed object may be any object, including, but not limited to, a pedestrian, a transportation vehicle (a car, a truck, a bicycle, and so on), an obstacle (a garbage can, a tree, a garbage, a traffic light, and so on), an animal (a dog, a cat, and so on), or a certain part of an object. For example, the to-be-photographed object is a human face, a license plate on a vehicle, or the like.

The following is illustrated in conjunction with the fact that the to-be-photographed object is a user to which the client belongs. In some embodiments, a plurality of beautification type controls are displayed on the object preview interface in response to detecting a beautification instruction triggered by the beautification control. The plurality of beautification type controls may include a beauty control, a beauty makeup control, a beauty body control, and a filter control. In some embodiments, in response to the client detecting the beautification instruction triggered by the beautification control, a control display page is displayed in a bottom region of the object preview interface, and a plurality of beautification type controls are displayed in the control display page. The beautification instruction triggered by the beautification control is an instruction generated in the case that the beautification control is triggered. For example, the client displays the object preview interface with the beautification control displayed, the user triggers the beautification control via the client, and the client detects the beautification instruction.

The beauty control is configured to adjust the shape of the parts in the person's face, the beauty makeup control is configured to adjust the makeup in the person's face, the beauty body control is configured to adjust other parts of the person. For example, the beauty body control is configured to adjust the thinness of the arms, and the filter control adds different filter effects to the to-be-photographed object.

In some embodiments, a plurality of different types of object adjustment controls are displayed in the object preview interface in response to the client detecting a beautification type display instruction triggered by the beautification control. For example, the object adjustment controls include a nose adjustment control for adjusting the width of the nose, a nose adjustment control for adjusting the height of the nose bridge, a puffy eyes adjustment control for adjusting the size of the puffy eyes, an apple muscle adjustment control for adjusting the position of the apple muscles, and an eyelid adjustment control for adjusting the width of the eyelids. adjustment control, a lip adjustment control for adjusting the thickness of the lip, a jaw line adjustment control for adjusting the curvature of the jaw line, and an adjustment control for adjusting the brightness of the face.

In some embodiments, the object adjustment control is a single-part adjustment control or, alternatively, a multi-parts combined adjustment control. For example, the multi-parts combined adjustment control includes a first combined adjustment control for adjusting nose width and nose bridge height, a second combined adjustment control for adjusting puffy eyes size and eyelid width, a third combined adjustment control for adjusting thickness of lip and jawline curvature.

In S203, in response to an adjustment instruction to the target sub-object of the to-be-photographed object, the target sub-object is adjusted.

In S205, position indication information is displayed in the object preview interface. The position indication information indicates a position of the adjusted target sub-object in the object preview interface.

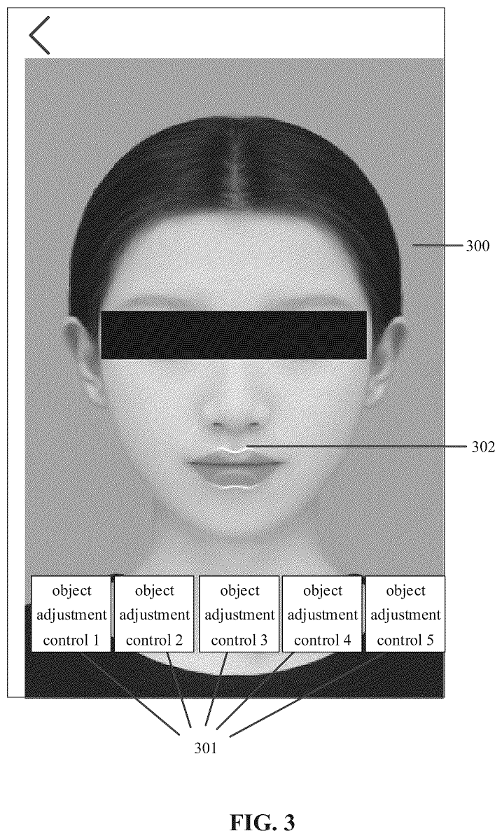

FIG. 3 is a schematic diagram of an object preview interface according to some embodiments of the present disclosure. As shown in FIG. 3, the object preview interface includes an object preview interface 300, a plurality of object adjustment controls 301, and position indication information 302, The object preview interface is configured to display a real-time to-be-photographed object, wherein the real-time to-be-photographed object is originated from a real-time state of the photographed person. The five object adjustment controls are illustrated in FIG. 3, the object adjustment controls are displayed on the object preview interface. The client, in response to left swipe, right swipe, and other gesture information of the user to the object preview interface, may display other object adjustment controls not currently displayed in the object preview interface.

In some embodiments of the present disclosure, taking the to-be-photographed object being a user's face captured in real-time as an example, the target sub-information of the to-be-photographed object includes, but not limited to, a nose (bridge of the nose or a nose), puffy eyes, apple muscles, eyelids, lips, a jawline, and facial skin, and the like.

In some embodiments, the client, in response to the adjustment instruction to the target sub-object of the to-be-photographed object, adjusts the target sub-object. In the case that the adjustment of the target sub-object is completed, position indication information 302 illustrating the position of the adjusted target sub-object is displayed in the object preview interface, as shown in FIG. 3.

The target sub-object shown in FIG. 3 is lips. That is, in the case that the user taps the lip adjustment control for adjusting the thickness of the lips, the client is able to generate the adjustment instruction for adjusting the lips and adjust the thickness of the lips. In the case that the adjustment of the thickness of the lips has been completed, the client displays the position indication information that indicates the position of the target sub-object after the adjustment. The position indication information can prompt the user for the corresponding position of the beautified face, enabling the user to be aware of the role of the object adjustment controls.

In some embodiments, the client responds to the adjustment instruction of the target sub-object by displaying a change of the target sub-object from the original form to the target form. For example, the client, in response to an adjustment instruction for lips in the to-be-photographed object, displays the lips changing from a thinner form to a thicker form, and the thinner form is the original form and the thicker form is the target form.

In some embodiments, during the process of changing the target sub-object from the original form to the target form, the client displays the first position indication information being changed to a second position indication information in the object preview interface. The first position indication information indicates a position of the target sub-object in the original form in the object preview interface. The second position indication information indicates a position of the target sub-object in the target form in the object preview interface.

In other words, the position indication information is changed along with the adjustment process of the target sub-object, and both the change in the form of the target sub-object and the change in the position of the position indication information are presented on the object preview interface, such that the user can see it.

In conjunction with FIG. 3, in the case that the user taps the lip adjustment control for adjusting the thickness of the lip, the client generates an adjustment instruction for adjusting the lip, and displays the first position indication information on the target sub-object in the original form. The client adjusts the target sub-object based on the adjustment instruction, and the target sub-object displayed by the client changes from the original form to the target form. During the process of changing the target sub-object from the original form to the target form, the first position indication information displayed in the object preview interface also changes with the changed target sub-object, until the target sub-object adjustment process is completed. In this time, the first position indication information of the target sub-object in the target form can be referred to as the second position indication information.

In some embodiments, the first position indication information of the target sub-object in the original form, as shown in FIG. 3, is on a contour line of the target sub-object in the original form. Similarly, a second position indication information is on a contour line of the target sub-object in the target form. In some embodiments, the position indication information (including the first position indication information and the second position indication information) is a curve along the contour line of the target sub-object. In some embodiments, the position indication information is a partial contour line of the target sub-object. In some embodiments, the position indication information may be the target sub-object itself by displaying the target sub-object with a color/shade distinguishable from other portions of the object. For example, position indication information may be a cheek of a human face being presented in a lighter or darker color than the rest of the face. The position indication information may be an appropriate indicator that point out the position being adjusted.

In some embodiments of the present disclosure, during the process of the target sub-object being adjusted, the position indication information is always displayed, and the position indication information can suggest the position of the target sub-object in the face before and after beautification, enabling the user to perceive the effect of the object adjustment control in a more targeted and complete manner.

In some embodiments of the present disclosure, the client adjusts the form of the target sub-object based on adjustment parameters. In some embodiments, the client generates an adjustment instruction corresponding to the application adjustment parameter in response to a determination instruction of the application adjustment parameter within the application adjustment parameter set corresponding to the target sub-object, and in response to the adjustment instruction corresponding to the application adjustment parameter, the form of the target sub-object is adjusted. The application adjustment parameter set is a collection of application adjustment parameters provided for the user, and in the case that the adjusting function is activated, the user is able to characterize the target sub-object through the client, using the application adjustment parameters in the application adjustment parameter set. The application adjustment parameter set includes one or more application adjustment parameters, and the application adjustment parameters are configured to adjust the target sub-object. In embodiments of the present disclosure, different target sub-objects correspond to different application adjustment parameter sets, e.g., the application adjustment parameter set corresponding to a nose is different from the application adjustment parameter set corresponding to lips.

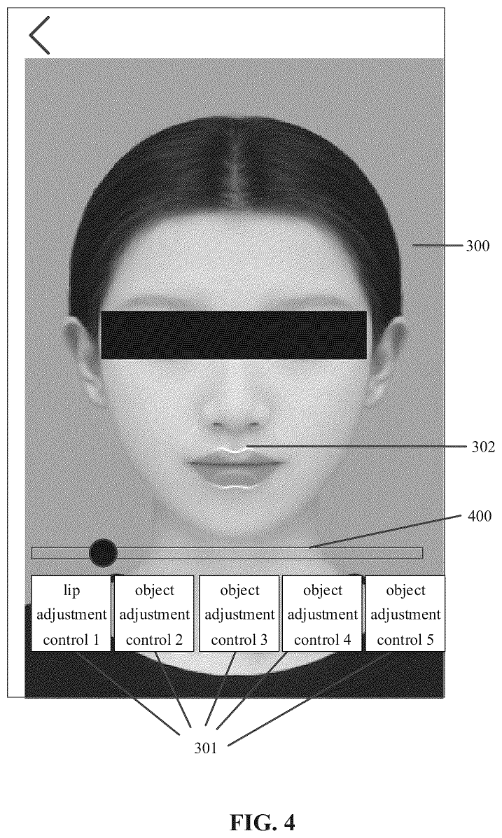

FIG. 4 is a schematic diagram of an object preview interface according to some embodiments of the present disclosure. As shown in FIG. 4, on the object preview interface 300, the plurality of object adjustment controls 301, the position indication information 302, and the parameter adjusting component 400 are displayed. In some embodiments, in the case that the client detects that a user taps the lip adjustment control 1 for adjusting the thickness of lips among the plurality of the object adjustment controls 301, the client displays, in the object preview interface, a parameter adjusting component 400 for adjusting the thickness of the lip. The parameter adjusting component 400 represents an application adjustment parameter set, i.e., a range of application adjustment parameters, that the user is able to use.

In the case that the client detects that a moveable part (the black dot for example in the example illustrated in FIG. 4) of the parameter adjusting component 400 moves on the adjustment lever, the client is able to determine the application adjustment parameter corresponding to the position of the black dot on the adjustment lever based on the position of the black dot on the adjustment lever, i.e., the client acquires an instruction for determining the application adjustment parameter, and subsequently generates an adjustment instruction corresponding to the application adjustment parameter. In some embodiments, the position of the moveable part on the adjustment lever may indicate that the magnitude of a parameter increases in one direction and decreases in another direction. For example, moving the moveable part toward right may increase the size of the target sub-object and moving the moveable part toward left may decrease the size of the target sub-object. Accordingly, the client may adjust the target sub-object based on the application adjustment parameter to change the target sub-object from the original form to the target form.

In some embodiments, in the absence of a parameter adjusting component, the adjustment parameter corresponding to the adjustment instruction to the target sub-object is a fixed parameter.

In some embodiments of the present disclosure, the object adjustment controls include a nose adjustment control for adjusting the width of the nose, a nose adjustment control for adjusting the height of the nose bridge, a puffy eyes adjustment control for adjusting the size of the puffy eyes, an apple muscle adjustment control for adjusting the position of the apple muscles, an eyelid adjustment control for adjusting the width of the eyelids, a lip adjustment control for adjusting the thickness of the lips, a jaw line adjustment control for adjusting that curvature of the jaw line, and a face brightness adjustment control, or includes a first integrated adjustment control for adjusting the width of the nose and the height of the nose bridge, a second integrated adjustment control for adjusting the size of the puffy eyes and adjusting the width of the eyelid, and a third integrated adjustment control for adjusting the thickness of the lip and adjusting the curvature of the jaw line. In this way, the adjustment parameter corresponding to the adjustment instruction includes at least one of the follows: a width adjustment parameter of a nose, a height adjustment parameter of a nose bridge, a size adjustment parameter of puffy eyes, a width adjustment parameter of double eyelids, a position adjustment parameter of apple muscles, a thickness adjustment parameter of lips, a curvature adjustment parameter of a jaw line, and a brightness adjustment parameter of a face.

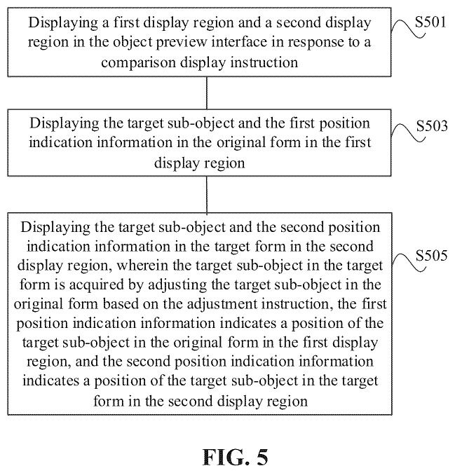

Embodiments of the present disclosure also provide a scheme for comparing before and after using an object adjustment control, so as to facilitate a user to observe changes before and after the adjustment. FIG. 5 is a flowchart of a method for displaying a target sub-object before and after adjustment according to some embodiments of the present disclosure. As shown in FIG. 5, the method includes the following steps.

In S501, in response to a comparison display instruction, a first display region and a second display region are displayed in the object preview interface.

In some embodiments, after the client, in response to the adjustment instruction to the target sub-object, completes the adjustment of the target sub-object, position indication information for indicating the position of the adjusted target sub-object is displayed in the object preview interface, and a comparison display control is also displayed in the object preview interface.

In some embodiments, the client displays the first display region and the second display region in the object preview interface in response to the comparison display instruction triggered by the comparison display control. The comparison display instruction triggered by the comparison display control is similar to the beautification instruction triggered by the beautification control described above, which is not repeated herein.

In some embodiments, the client, in response to the adjustment instruction to the target sub-object, displays the target sub-object being changed from the original form to the target form, synchronously displays the change of the first position indication information to the second position indication information, and displays the comparison display control in the object preview interface.

In some embodiments, the client displays the first display region and the second display region in the object preview interface in response to the comparison display instruction triggered by the comparison display control.

In some embodiments, the to-be-photographed object is displayed in the object preview interface, and the comparison display control is simultaneously displayed in the object preview interface. In some embodiments, the client displays the first display region and the second display region in the object preview interface in response to the comparison display instruction triggered by the comparison display control.

In S503, the target sub-object and the first position indication information in the original form are displayed in the first display region.

In S505, the target sub-object and the second position indication information in the target form are displayed in the second display region. The target sub-object in the target form is acquired by adjusting the target sub-object in the original form based on the adjustment instruction, the first position indication information indicates a position of the target sub-object in the original form in the first display region, and the second position indication information indicates a position of the target sub-object in the target form in the second display region.

In some embodiments, the comparison display instruction is triggered after the adjustment of the target sub-object is completed, and the client is able to display the target sub-object in the original form and the first position indication information in the first display region, and display the target sub-object in the target form and the second position indication information in the second display region. The target sub-object in the target form is acquired by adjusting the target sub-object in the original form based on the adjustment instruction. The first position indication information indicates a position of the target sub-object in the original form in the first display region, and the second position indication information indicates a position of the target sub-object in the target form in the second display region.

In the embodiments of the present disclosure, upon completion of the adjustment of the target sub-objects, the target sub-objects before and after adjustment and the position indication information are displayed on the object preview interface based on the comparison display instruction, such that the user can make a clear comparison between the target sub-objects before and after adjustment, thereby improving the user experience.

In some embodiments, while the to-be-photographed object is displayed in the object preview interface, a comparison display control is displayed in the object preview interface, and the client, in response to the comparison display instruction triggered by the comparison display control, displays a first display region and a second display region in the object preview interface, and displays the to-be-photographed object in the first display region and the second display region. The to-be-photographed object in the first display region and the second display region pertains to the to-be-photographed object prior to adjustment. Thereafter, the client, in response to the adjustment instruction to the target sub-object of the to-be-photographed object, displays the first position indication information on the target sub-object in the original form within the first display region, displays the target sub-object being changed from the original form to the target form in the second display region, and displays second position indication information on the target sub-object in the target form.

In this way, the embodiment of the present disclosure divides the object preview interface into two display regions based on the comparison display instruction prior to the adjustment of the target sub-object. At this time, the two display regions display the current to-be-photographed object, and the display contents of the two display regions are the same. In response to detecting the adjustment instruction to the target sub-object, the target sub-objects before and after adjustment and the position indication information are displayed in the two display regions based on the adjustment instruction, such that the user can make a comparison more clearly and intuitively between the target sub-objects before and after adjustment during the entire process of adjustment through the side by side comparison, thereby improving the user experience.

In the embodiments of the present disclosure, because the entire process of adjusting the form of the target sub-object is realized prior to photographing, in the case that the adjustment of the target sub-object of the to-be-photographed object is completed, in response to the photographing instruction, the to-be-photographed object including the adjusted target sub-object is photographed, and the target image is acquired.

It should be noted that the embodiment shown in FIG. 5 is based on first displaying the first display region and the second display region, and then performing S502 and S503. In another embodiment, instead of performing S501 to S503, in response to the comparison display instruction, the target sub-object in the original form and the first position indication information are displayed in a first display region of the object preview interface, and the target sub-object in the target form and the second position indication information are displayed in the second display region of the object preview interface.

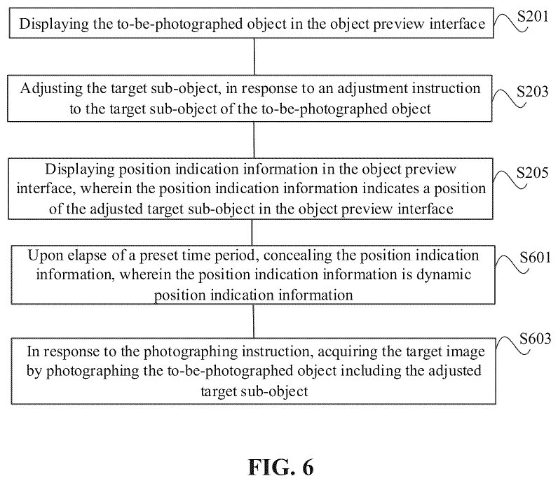

FIG. 6 is a flowchart of a method for photographing a to-be-photographed object according to some embodiments of the present disclosure. As shown in FIG. 6 the method includes the following steps.

In S601, upon elapse of a preset time period, the position indication information is concealed, wherein the position indication information is dynamic position indication information.

In some embodiments of the present disclosure, in the case that the adjustment of the target sub-object on the client side is completed, the position indication information for indicating the position of the adjusted target sub-object is displayed in the object preview interface, and thereafter, the position indication information is concealed upon elapse of the preset time period.

Alternatively, in the case that the client displays that the target sub-object has been changed from the original form to the target form, and synchronously displays that the first position indication information has been changed to the second position indication information, and upon elapse of the preset time period, the position indication information is concealed.

The position indication information (including the first position indication information and the second position indication information) is dynamic position indication information. For example, the position indication information is a flashing curve.

In some embodiments, the preset time period is an arbitrary period of time set in advance. For example, the preset time period is 2 seconds.

In S603, in response to the photographing instruction, the target image is acquired by photographing the to-be-photographed object including the adjusted target sub-object.

As described above, the object preview interface includes a photographing control. In the case that the client detects that the region corresponding to the photographing control is tapped, based on the photographing instruction triggered by the photographing control, the to-be-photographed object including the target sub-object in the target form is photographed, and the target image is acquired. The photographing instruction triggered by the photographing control is similar to the beautification instruction triggered by the beautification control described above, which is not repeated herein.

In some embodiments, the position indication information may also be displayed on the object preview interface before the client detects that the region corresponding to the photographing control is tapped. In the case that the client detects that the region corresponding to the photographing control is tapped, based on the photographing instruction triggered by the photographing control, the to-be-photographed object including the target sub-object in the target form is photographed, and the target image is acquired. In some embodiments of the present disclosure, the target image does not include position indication information.

In this way, in the embodiment of the present disclosure, the target image desired by the user is acquired while the adjustment of the target sub-object of the to-be-photographed object is completed.

In the embodiment of the present disclosure, the above involved client is the user's client, that is, after an application or an installation package providing a function is downloaded by the user's client, the user is capable of using the function to complete photographing the to-be-photographed object. However, the client involved above may be a developer's client, that is, after the application or installation package providing a function is downloaded by the developer's client, the developer is able to use the function to complete photographing the to-be-photographed object to see whether the captured image is valid or not.

For the developer's client, embodiments of the present disclosure also provide a method for determining an application adjustment parameter set for a target sub-object using an object preview interface.

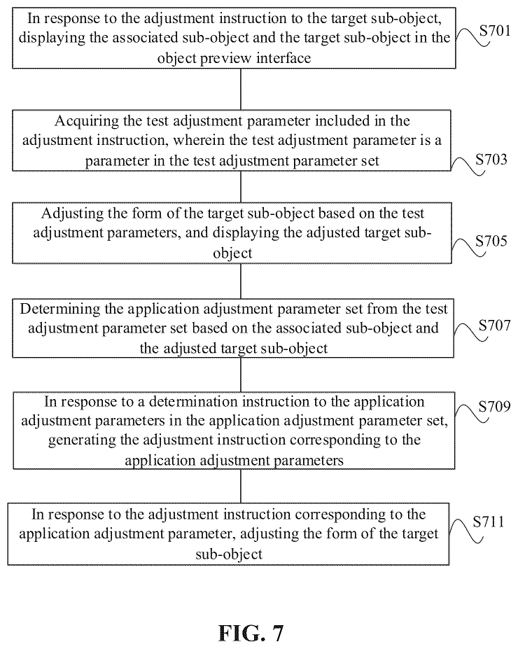

FIG. 7 is a flowchart of adjusting an adjustment parameter according to some embodiments of the present disclosure. As shown in FIG. 7, the method includes the following steps.

In S701, in response to the adjustment instruction to the target sub-object, the associated sub-object and the target sub-object are displayed in the object preview interface. The associated sub-object is a sub-object of the to-be-photographed object associated with the target sub-object.

In the function testing phase, in the case that the developer's client has downloaded an installation package having the object adjusting function, the image acquisition application on the client has the object adjusting function, and the developer is able to open the image acquisition application on the client, display the object preview interface through the image acquisition application, and display the to-be-photographed object in the object preview interface.

In some embodiments, the developer's client displays the associated sub-object and the target sub-object in the object preview interface in response to an adjustment instruction to the target sub-object. The associated sub-object is a sub-object of the to-be-photographed object that is associated with the target sub-object. For example, in the case that the to-be-photographed object is the upper body of a person, the associated sub-object is the face in the upper body of the person, the associated sub-object is a portion of the to-be-photographed object, and the portion corresponding to the associated sub-object includes the target sub-object. Because for a developer, in order to see the before and after adjustment process as clearly as possible, sub-object of the to-be-photographed object that is less related to the target sub-object (such as the neck portion in the upper body of the person) are eliminated, and only the portion that is closely related to the adjustment process is left.

In embodiments of the present disclosure, the reason for leaving the associated sub-objects that is related to the target sub-object is that the associated sub-objects are needed to be a reference to determine the reasonableness and aesthetics of the target sub-object before and after the adjustment.

In S703, the test adjustment parameter included in the adjustment instruction is acquired. The test adjustment parameter is a parameter in the test adjustment parameter set.

In some embodiments of the present disclosure, the developer's client is configured to acquire the test adjustment parameter set from an installation package, present a parameter adjusting component corresponding to the test adjustment parameter set on the object preview interface, and the object preview interface displays a parameter adjusting component corresponding to the test adjustment parameter set. The developer is capable of adjusting a position of a moveable part (e.g., a black dot) on the adjustment lever on the parameter adjusting component, and the client, based on the position of the moveable part on the adjustment lever, determines the test adjustment parameter corresponding to that position in the test adjustment parameter set. The determined test adjustment parameter is the test adjustment parameter included in the adjustment instruction. The test adjustment parameter set is a collection of test adjustment parameters developed by the developer for the target sub-object, and the test adjustment parameter set includes one or more test adjustment parameters.

In S705, the form of the target sub-object is adjusted based on the test adjustment parameters, and the adjusted target sub-object is displayed.

In some embodiments, the developer's client adjusts the form of the target sub-object based on the test adjustment parameters, and displays the associated sub-object and the adjusted target sub-object. The associate sub-object is not adjusted, but is determined as a reference for the adjusted target sub-object. In the case that the associate sub-object and the adjusted target sub-object are displayed, the position indication information can be displayed on the adjusted target sub-object.

In S707, the application adjustment parameter set is determined from the test adjustment parameter set based on the associated sub-object and the adjusted target sub-object.

In the embodiment of the present disclosure, in the process of realizing the adjustment of the target sub-object by the developer's client based on different test adjustment parameters, the developer is able to determine which test adjustment parameters are unreasonable, i.e., to determine that there are unreasonable test adjustment parameters in the test adjustment parameter set, based on the adjusted target sub-object and associated sub-object displayed by the client. Therefore, the developer's client, based on the associated sub-object and the adjusted target sub-object, filters reasonable test adjustment parameters from the test adjustment parameter set, and the filtered test adjustment parameters as the application adjustment parameters constitute the application adjustment parameter set.

In S709, in response to a determination instruction to the application adjustment parameters in the application adjustment parameter set, the adjustment instruction corresponding to the application adjustment parameters is generated.

Next, the developer's client realizes re-adjustment of the target sub-object based on the application adjustment parameters in the re-determined application adjustment parameter set, in order to test whether each application test parameter in the application adjustment parameter set is reasonable. In some embodiments, the client, in response to the instruction to determine the application adjustment parameters in the application adjustment parameter set, generates the adjustment instruction corresponding to that application adjustment parameter. The application adjustment parameter set corresponds to the target sub-object.

In S711, in response to the adjustment instruction corresponding to the application adjustment parameter, the form of the target sub-object is adjusted.

In some embodiments, the developer's client adjusts the form of the target sub-object in response to the adjustment instructions corresponding to the application adjustment parameters.

In this way, the developer's client, in conjunction with the display of the front-end interface, through testing the test adjustment parameters in the test adjustment parameter set corresponding to the target sub-object, filters reasonable test adjustment parameters from the test adjustment parameter set, and forms the application adjustment parameter set by taking the filtered test adjustment parameters as the application adjustment parameters, that is, obtains the application adjustment parameter set of the target sub-object that is available for practical application by the user.

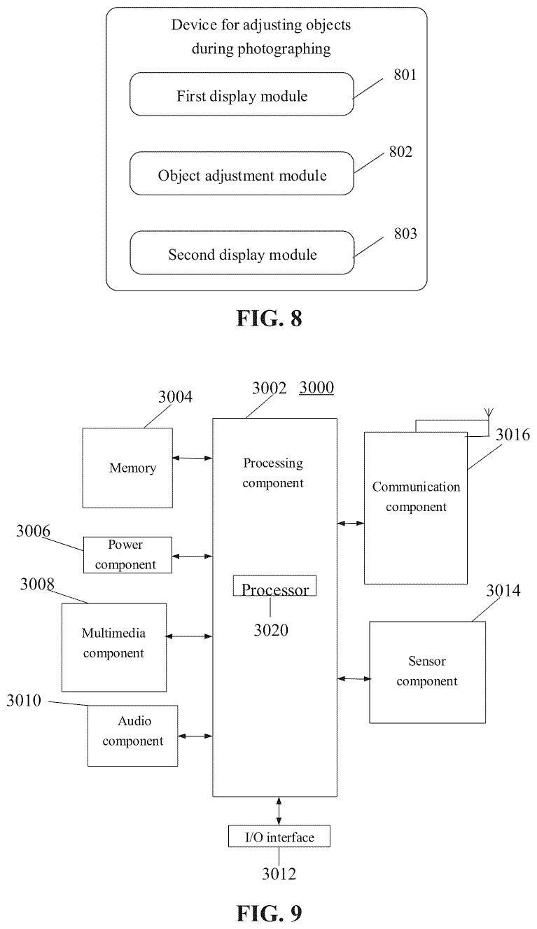

FIG. 8 is a block diagram of an apparatus for adjusting objects during photographing according to some embodiments of the present disclosure. The apparatus has a function of realizing the data processing method in the method embodiment described above, and the function is implemented by hardware or by hardware running corresponding software. Referring to FIG. 8, the apparatus includes a first display module 801, an object adjustment module 802, and a second display module 803.

The first display module 801 is configured to display a to-be-photographed object in an object preview interface.

The object adjustment module 802 is configured to adjust the target sub-object in response to an adjustment instruction of the target sub-object of the to-be-photographed object.

The second display module 803 is configured to display position indication information in the object preview interface. The position indication information indicates a position of the adjusted target sub-object in the object preview interface.

In some possible embodiments, the object adjustment module is configured to display a target sub-object being changed from an original form to a target form in response to an adjustment instruction to the target sub-object.

In some possible embodiments, the second display module is configured to display, in the object preview interface, a change of the first position indication information to a second position indication information during the change of the target sub-object from the original form to the target form.

The first position indication information indicates a position of the target sub-object in the original form in the object preview interface. The second position indication information indicates a position of the target sub-object in the target form in the object preview interface.

In some possible embodiments, the apparatus further includes a third display module. The third display module is configured to: display, in response to a comparison display instruction, the target sub-object in an original form and first position indication information in a first display region of the object preview interface, and display the target sub-object in a target form and second position indication information in a second display region of the object preview interface.

The target sub-object in the target form is acquired by adjusting the target sub-object in the original form based on the adjustment instruction.

The first position indication information indicates a position of the target sub-object in the original form in the first display region. The second position indication information indicates a position of the target sub-object in the target form in the second display region.

In some possible embodiments, the object adjustment module is configured to: display an associated sub-object and the target sub-object in the object preview interface in response to the adjustment instruction to the target sub-object, wherein the associated sub-object is a sub-object of the to-be-photographed object associated with the target sub-object; acquire a test adjustment parameter contained in the adjustment instruction; and adjust a form of the target sub-object based on the test adjustment parameter, and display the adjusted target sub-object.

In some possible embodiments, the test adjustment parameter is a parameter in the test adjustment parameter set. The object adjustment module is configured to: determine an application adjustment parameter set from the test adjustment parameter set based on the associated sub-object and the adjusted target sub-object; generate the adjustment instruction corresponding to an application adjustment parameter in response to a determination instruction to the application adjustment parameter in the application adjustment parameter set; and adjust the form of the target sub-object in response to the adjustment instruction corresponding to the application adjustment parameter.

In some possible embodiments, the adjustment parameter corresponding to the adjustment instruction includes at least one of: a width adjustment parameter of a nose, a height adjustment parameter of a nose bridge, a size adjustment parameter of puffy eyes, a width adjustment parameter of double eyelids, a position adjustment parameter of apple muscles, a thickness adjustment parameter of lips, a curvature adjustment parameter of a jaw line, and a brightness adjustment parameter of a face.

In some possible embodiments, the apparatus further includes a photographing module. The photographing module is configured to, in response to a photographing instruction, acquire a target image by photographing the to-be-photographed object including the adjusted target sub-object.

In some possible embodiments, the apparatus further includes an information concealing module. The information concealment module is configured to conceal the position indication information upon elapse of a preset time period.

The position indication information is dynamic position indication information.

It should be noted that the apparatus provided in the above embodiments, in realizing its functions, is only exemplified by the division of each of the above function modules. In actual application, the above functions are assigned to be accomplished by different function modules based on the needs, i.e., the internal structure of the apparatus is divided into different function modules in order to accomplish all or part of the above functions. In addition, the device provided in the above embodiment belongs to the same concept as the method embodiment, and its specific realization process is described in detail in the method embodiment, which is not repeated herein.

FIG. 9 is a block diagram of a device 3000 for adjusting objects during photographing according to some embodiments of the present disclosure. For example, the device 3000 is a phone, a computer, a digital broadcasting terminal, a message transceiver device, a game console, a tablet device, a medical device, a fitness device, a personal digital assistant, or the like.

Referring to FIG. 9, the device 3000 includes one or more of: a processing component 3002, a memory 3004, a power component 3006, a multimedia component 3008, an audio component 3010, an input/output (I/O) interface 3012, a sensor component 3014, and a communication component 3016.

The processing component 3002 generally controls the overall operation of the device 3000, such as operations associated with displays, telephone calls, data communications, camera operations, and recording operations. The processing component 3002 includes one or more processors 3020 to execute instructions to accomplish all or some of the steps of the method described above. In addition, the processing component 3002 includes one or more modules to facilitate interaction between the processing component 3002 and other components. For example, the processing component 3002 includes a multimedia module to facilitate interaction between the multimedia component 3008 and the processing component 3002.

The memory 3004 is configured to store various types of data to support operation of the device 3000. For examples, the data includes instructions for any application or method operated on the device 3000, contact data, phone book data, messages, photos, videos, and the like. The memory 3004 is implemented by any type of volatile or non-volatile storage device or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a disk, or a compact disc read-only memory (CD-ROM).

The power supply assembly 3006 supplies power to various components of the device 3000. The power supply component 3006 includes a power management system, one or more power supplies, and other components associated with generating, managing, and distributing power for the device 3000.

The multimedia component 3008 includes a screen providing an output interface between the device 3000 and a user. In some embodiments, the screen may include a liquid crystal display (LCD) and a touch panel (TP). In the case that the screen includes a touch panel, the screen is implemented as a touch screen to receive input signals from the user. The touch panel includes one or more touch sensors to sense touches, swipes and gestures on the touch panel. The touch sensors can not only sense the boundaries of a touch or swipe action, but also detect the duration and pressure associated with the touch or swipe operation. In some embodiments, the multimedia component 3008 includes a front camera and/or a rear camera. The front camera and/or the rear camera may receive external multimedia data in the case that the device 3000 is in an operating mode, such as a photographing mode or a video mode. Each front camera and rear camera may be a fixed optical lens system or have a focal length and optical zoom capability.

The audio component 3010 is configured to output and/or input audio signals. For example, the audio component 3010 includes a microphone (MIC) that is configured to receive external audio signals in the case that the device 3000 is in an operational mode, such as a call mode, a recording mode, and a voice recognition mode. The received audio signals are further stored in memory 3004 or sent via communication component 3016. In some embodiments, the audio component 3010 further includes a speaker for outputting audio signals.

The I/O interface 3012 provides an interface between the processing component 3002 and a peripheral interface module, and the peripheral interface module is a keypad, a click wheel, a button, or the like. The button herein includes, but is not limited to, a home button, a volume button, a start button, and a lock button.

The sensor assembly 3014 includes one or more sensors for providing status assessment of various aspects of the device 3000. For example, the sensor assembly 3014 detects an on/off state of the device 3000 and the relative positioning of components. For example, the components are the display and keypad of the device 3000, the sensor assembly 3014 detects a change in the position of the device 3000 or one of the components of the device 3000, the presence or absence of user contact with the device 3000, a change in the orientation of the device 3000 or acceleration/deceleration and a change in temperature of the device 3000. The sensor assembly 3014 includes a proximity sensor configured to detect the presence of a nearby object in the absence of any physical contact. The sensor assembly 3014 further includes an optical sensor, such as a CMOS or CCD image sensor, for use in imaging applications. In some embodiments, the sensor assembly 3014 further includes an acceleration sensor, a gyroscope sensor, a magnetic sensor, a pressure sensor, or a temperature sensor.

The communication component 3016 is configured to facilitate communication between the device 3000 and other devices by wired or wireless means. The device 3000 has access to a wireless network based on a communication standard, such as Wi-Fi, a carrier network (e.g., 2G, 3G, 4G, or 5G), or a combination thereof. In some embodiments of the present disclosure, the communication component 3016 receives broadcast signals or broadcast-related information from an external broadcast management system via a broadcast channel. In some embodiments of the present disclosure, the communication component 3016 further includes a near field communication (NFC) module to facilitate short range communication. For example, the NFC module is implemented based on radio frequency identification (RFID), infrared data association (IrDA), ultra-wideband (UWB), Bluetooth (BT), and other technologies.

In some embodiments, the device 3000 is implemented by one or more application-specific integrated circuits (ASIC), digital signal processors (DSP), digital signal processing devices (DSPD), programmable logic devices (PLD), field-programmable gate arrays (FPGA), controllers, microcontrollers, microprocessors, or other electronic components for performing the above method embodiments providing the method for adjusting objects during photographing according to the above method embodiments.

Embodiments of the present disclosure also provide a computer-readable storage medium. The computer-readable storage medium is disposed in an electronic device and stores one or more instructions or one or more programs for performing a method for adjusting objects during photographing. The one or more instructions or the one or more programs, when loaded and run by processor, cause the electronic device to perform the method for adjusting objects during photographing according to the above method embodiments.

In exemplary embodiments, a storage medium including one or more instructions therein is also provided, such as a memory 3004 including one or more instructions. The one or more instructions, when loaded and executed by a processor 3020 of the device 3000, cause the device 300 to perform the above method. In some embodiments, the storage medium is a non-transitory computer-readable storage medium. For example, the non-transitory computer-readable storage medium is a ROM, a random access memory (RAM), a CD-ROM, a magnetic tape, a floppy disk, an optical data storage device, or the like.

Embodiments of the present disclosure also provide a computer-readable storage medium storing one or more instructions therein. The one or more instructions, when loaded and executed by a processor of an electronic device, cause the electronic device to perform the method for adjusting objects during photographing according to the above method embodiments.

Embodiments of the present disclosure also provide a computer program product. The computer program product includes one or more computer programs. The one or more computer programs are stored in a readable storage medium. The one or more computer programs, when loaded and run by at least one processor of a computer device, cause the computer device to perform the method for adjusting objects during photographing according to the above method embodiments.

All embodiments of the present disclosure can be performed alone or in combination with other embodiments, and are considered to be within the scope of protection of the claims of the present disclosure.

What is claimed is:

1. A method for adjusting objects during photographing, performed by an electronic device, comprising:
displaying a to-be-photographed object in an object preview interface;
adjusting a target sub-object in response to an adjustment instruction to the target sub-object of the to-be-photographed object; and
displaying position indication information in the object preview interface, wherein the position indication information indicates a position of the adjusted target sub-object in the object preview interface.

2. The method according to claim 1, wherein the position indication information is a curve along a contour line of the target sub-object or the position indication information is a partial contour line of the target sub-object.

3. The method according to claim 1, further comprising:
displaying a parameter adjustment component in the object preview interface, wherein the parameter adjustment component represents a range of application adjustment parameters available for a user to adjust the target sub-object, and the parameter adjustment component includes an adjustment lever and a moveable part located on the adjustment lever, and wherein the electronic device is configured to determine an application adjustment parameter corresponding to a position of a moveable part on the adjustment lever and adjust the target sub-object accordingly.

4. The method according to claim 1, wherein adjusting the target sub-object in response to the adjustment instruction to the target sub-object of the to-be-photographed object comprises:
displaying the target sub-object being changed from an original form to a target form in response to the adjustment instruction to the target sub-object.

5. The method according to claim 4, wherein displaying the position indication information in the object preview interface comprises:
displaying, in the object preview interface, first position indication information being changed to second position indication information in a process that the target sub-object is being changed from the original form to the target form;
wherein the first position indication information indicates a position of the target sub-object in the original form in the object preview interface, and the second position indication information indicates a position of the target sub-object in the target form in the object preview interface.

6. The method according to claim 1, further comprising:
displaying, in response to a comparison display instruction, the target sub-object in an original form and first position indication information in a first display region of the object preview interface, and displaying the target sub-object in a target form and second position indication information in a second display region of the object preview interface; wherein
the target sub-object in the target form is acquired by adjusting the target sub-object in the original form based on the adjustment instruction; and
the first position indication information indicates a position of the target sub-object in the original form in the first display region, and the second position indication information indicates a position of the target sub-object in the target form in the second display region.

7. The method according to claim 1, wherein adjusting the target sub-object in response to the adjustment instruction to the target sub-object of the to-be-photographed object comprises:
displaying an associated sub-object and the target sub-object in the object preview interface in response to the adjustment instruction to the target sub-object, wherein the associated sub-object is a sub-object of the to-be-photographed object associated with the target sub-object;
acquiring a test adjustment parameter contained in the adjustment instruction; and
adjusting a form of the target sub-object based on the test adjustment parameter, and displaying the adjusted target sub-object.

8. The method according to claim 7, wherein the test adjustment parameter is a parameter in a test adjustment parameter set, and the method further comprises:
determining an application adjustment parameter set from the test adjustment parameter set based on the associated sub-object and the adjusted target sub-object;
generating the adjustment instruction corresponding to an application adjustment parameter in response to a determination instruction to the application adjustment parameter in the application adjustment parameter set; and
adjusting the form of the target sub-object in response to the adjustment instruction corresponding to the application adjustment parameter.

9. The method according to claim 1, wherein an adjustment parameter corresponding to the adjustment instruction comprises at least one of:
a width adjustment parameter of a nose, a height adjustment parameter of a nose bridge, a size adjustment parameter of puffy eyes, a width adjustment parameter of double eyelids, a position adjustment parameter of apple muscles, a thickness adjustment parameter of lips, a curvature adjustment parameter of a jaw line, and a brightness adjustment parameter of a face.

10. The method according to claim 1, further comprising: in response to a photographing instruction, acquiring a target image by photographing the to-be-photographed object comprising the adjusted target sub-object.

11. The method according to claim 1, wherein the method further comprises: concealing the position indication information upon elapse of a preset time period;
wherein the position indication information is dynamic position indication information.

12. An electronic device, comprising:
a processor; and
a memory, configured to store one or more instructions executable by the processor;
wherein the processor, when loading and executing the one or more instructions, is caused to:
display a to-be-photographed object in an object preview interface;
adjust a target sub-object in response to an adjustment instruction to the target sub-object of the to-be-photographed object; and
display position indication information in the object preview interface, wherein the position indication information indicates a position of the adjusted target sub-object in the object preview interface.

13. The electronic device according to claim 12, wherein the processor, when loading and executing the one or more instructions, is caused to:
display the target sub-object being changed from an original form to a target form in response to the adjustment instruction to the target sub-object.

14. The electronic device according to claim 13, wherein the processor, when loading and executing the one or more instructions, is caused to:
display, in the object preview interface, first position indication information being changed to second position indication information in a process that the target sub-object is being changed from the original form to the target form;
wherein the first position indication information indicates a position of the target sub-object in the original form in the object preview interface, and the second position indication information indicates a position of the target sub-object in the target form in the object preview interface.

15. The electronic device according to claim 12, wherein the processor, when loading and executing the one or more instructions, is caused to:
display, in response to a comparison display instruction, the target sub-object in an original form and first position indication information in a first display region of the object preview interface, and display the target sub-object in a target form and second position indication information in a second display region of the object preview interface;
wherein the target sub-object in the target form is acquired by adjusting the target sub-object in the original form based on the adjustment instruction; and
the first position indication information indicates a position of the target sub-object in the original form in the first display region, and the second position indication information indicates a position of the target sub-object in the target form in the second display region.

16. The electronic device according to claim 12, wherein the processor, when loading and executing the one or more instructions, is caused to:
display an associated sub-object and the target sub-object in the object preview interface in response to the adjustment instruction to the target sub-object, wherein the associated sub-object is a sub-object of the to-be-photographed object associated with the target sub-object;
acquire a test adjustment parameter contained in the adjustment instruction; and
adjust a form of the target sub-object based on the test adjustment parameter, and display the adjusted target sub-object.

17. The electronic device according to claim 16, wherein the test adjustment parameter is a parameter in a test adjustment parameter set, and the processor, when loading and executing the one or more instructions, is caused to:
determine an application adjustment parameter set from the test adjustment parameter set based on the associated sub-object and the adjusted target sub-object;
generate the adjustment instruction corresponding to an application adjustment parameter in response to a determination instruction to the application adjustment parameter in the application adjustment parameter set; and
adjust the form of the target sub-object in response to the adjustment instruction corresponding to the application adjustment parameter.

18. The electronic device according to claim 12, wherein an adjustment parameter corresponding to the adjustment instruction comprises at least one of:
a width adjustment parameter of a nose, a height adjustment parameter of a nose bridge, a size adjustment parameter of puffy eyes, a width adjustment parameter of double eyelids, a position adjustment parameter of apple muscles, a thickness adjustment parameter of lips, a curvature adjustment parameter of a jaw line, and a brightness adjustment parameter of a face.

19. The electronic device according to claim 12, wherein the processor, when loading and executing the one or more instructions, is caused to:
in response to a photographing instruction, acquire a target image by photographing the to-be-photographed object comprising the adjusted target sub-object.

20. A non-transitory computer readable storage medium storing one or more instructions, wherein the one or more instructions, when loaded and executed by a processor of an electronic device, cause the electronic device to:
display a to-be-photographed object in an object preview interface;
adjust a target sub-object in response to an adjustment instruction to the target sub-object of the to-be-photographed object; and
display position indication information in the object preview interface, wherein the position indication information indicates a position of the adjusted target sub-object in the object preview interface.
